(19) United States
(12) Patent Application Publication
(10) Pub. No.: US 2015/0308331 A1
(43) Pub. Date: Oct. 29, 2015

(54) ENGINE CONTROL METHOD FOR COLD START STABILIZATION

(71) Applicants: Hyundai Motor Company, Seoul (KR); Kia Motors Corporation, Seoul (KR)

(72) Inventors: Hyun-Soo Song, Hwaseong (KR); Chang-Hyun Ha, Seoul (KR)

(21) Appl. No.: 14/547,687

(22) Filed: Nov. 19, 2014

(30) Foreign Application Priority Data
Apr. 28, 2014 (KR) 10-2014-0050583

(51) Int. Cl. F02B 37/24; F02D 41/22; F02D 41/06; F02D 41/00

(52) U.S. Cl. CPC F02B 37/24; F02D 41/0007; F02D 41/22; F02D 41/064; F02D 41/061

(57) ABSTRACT

An engine control method for cold start stabilization is provided. The method includes detecting, by a controller, a cold start based on a cold start condition of a soaking condition of an engine in response to sensing a starting of the engine. In addition, a turbo charger is operated with a control value of a vane corresponding to a first allocated bit. After the cold start, either a normal control is performed to operate the turbo charger according to an engine running condition or cold start-2 is performed to again operate the turbo charger with a control value of the vane corresponding to a second allocated bit and then performing the normal control.

### CROSS-REFERENCE TO RELATED APPLICATION

This application claims priority to Korean Patent Application No. 10-2014-0050583, filed on Apr. 28, 2014, the disclosure of which is incorporated herein by reference in its entirety.

### BACKGROUND

1. Field of the Invention

The present invention relates to an engine, and more particularly, to an engine control method and system for cold start stabilization by which the engine revolutions per minute (RPM) is prevented from rapidly changing during a cold start.

2. Description of the Related Art

In general, when an engine to which a turbo charger is applied starts, it is necessary to prevent the turbo charger, in which external air is compressed to achieve a substantially high compression ratio, from being damaged or broken. Accordingly, a startup boost control logic is applied. The startup boost control logic is configured to sense a cold start condition during a target period of time within a set engine RPM before or after cranking and to perform a cold start control and a post-cold start control separately.

The cold start control is performed during a preset period of time after an engine starts. For the cold start control, cold start conditions are determined using cold start determination factors that include the operating state of the engine, the RPM of the engine, and a set maintenance time of a turbo charger vane. Therefore, the cold start control may be performed before cranking, or may be performed by sensing cold start determination factors during a target period of time within a set engine RPM after cranking. Accordingly, on a cold start control, a turbo charger is operated according to a control value of a vane which corresponds to an allocated bit, thus reducing the risk of damage which may be caused by an RPM of the turbo charger exceeding a limit thereof before oil reaches the turbo charger, and to improve the startability thereof.

The post-cold start control is a boost control performed when a predetermined period of time has elapsed after the starting of the engine and thus the cold start control has been completed. In such a boost control, the turbo charger is operated by either a closed loop control which is performed in a scheme of adjusting a target boost pressure, or by an open loop control which is performed in a scheme of adjusting a boost pre-control value. When the startup boost control logic is implemented as described above, the turbo charger can be driven without damage even on the cold start of the engine.

However, when the startability of the cold start is improved by opening the turbo charger vane, and idle stability after starting is ensured by closing the turbo charger vane, the vane may suddenly move within the turbo charger, and also the engine RPM may be suddenly changed. Such a sudden change in the engine RPM may cause an unstable operation of the engine.

### SUMMARY

Accordingly, the present invention provides an engine control method and system for cold start stabilization wherein a cold start condition is divided into two stages based on an engine running state, an engine RPM, a set maintenance time of a turbo charger vane, and a change of the engine RPM based on a change of the duty of the turbo charger vane, and the RPM of the turbo charger vane may be adjusted in multiple steps, to improve the startability of cold start without the danger of damage of the turbo charger, and particularly, that a sudden movement of the vane causing a sudden change in the engine RPM may be prevented during a turbo charger control performed after the cold start, thereby achieving a more stable engine operation.

In accordance with one aspect of the present invention, an engine control method for cold start stabilization may include: detecting cold start with respect to a cold start condition of an engine soaking condition in an engine control unit (ECU) which has sensed the start of the engine; operating a turbo charger with a control value of a vane that corresponds to an allocated bit after the cold start is determined; and after the cold start, either performing a normal control to operate the turbo charger according to an engine running condition, or repeating a cold start-2 to again operate the turbo charger with a control value of the vane that corresponds to a newly allocated bit and then performing the normal control. The cold start-2 may not be executed when a set time is zero, and the normal control (e.g., a boost control as the post-cold start control) may be performed when the cold start-2 is not executed.

In particular, the cold start may be detected using an engine running state, an engine RPM, and a set maintenance time of a turbo charger vane. The cold start may determine based on a condition that a change of an engine RPM depending on a change in the duty of the vane of the turbo charger is minimal. The process of operating the turbo charger may include: determining Before Cranking or After Cranking in a detected engine running state; and executing the cold start control on the condition of the Before Cranking, while executing the cold start control or performing the normal control on the condition of the After Cranking.

In connection with the condition of the After Cranking, the method may include: setting a detected engine RPM as a first checked RPM; comparing the first checked RPM with a first set starting RPM; entering a normal mode when the first checked RPM is greater than the first set starting RPM, while detecting an engine running time [sec] condition when the first checked RPM is equal to or less than the first set starting RPM; comparing the detected engine running time [sec] with a first set engine running time [sec] in lengths thereof; and entering the normal mode when the first detected engine running time [sec] is greater than the first set engine running time [sec], while executing a control for the cold start when the first detected engine running time[sec] is equal to or less than the first set engine running time [sec].

In the repeated process of operating the turbo charger, the cold start-2 may be determined under a condition that a change of an engine RPM depending on a change in a duty of the vane of the turbo charger is substantial. The process may include: determining a set time of the cold start-2 after completing the cold start; and performing the normal control when the set time is conditioned to be zero, while executing a control for the cold start-2 when the set time is conditioned to be greater than zero.

The control for the cold start-2 may include: determining a normal running of a detected engine running state; setting an additionally detected engine RPM as a second detected RPM; comparing the second detected RPM with a second set starting RPM; setting an additionally detected engine running time [sec] as a second set engine running time [sec] when the second detected RPM is equal to or less than the second set starting RPM; comparing the second checked engine running time [sec] with a second set engine running time [sec] in lengths thereof; and executing a control for the cold start-2 when the second detected engine running time [sec] is equal to or less than the second set engine running time [sec].

In determination of a normal running of a detected engine running state, an entry into the normal mode may be performed when normal running is not detected. In addition, in the process of setting an additionally detected engine running time as a second set engine running time, an entry into the normal mode may be performed when the second detected RPM is greater than the second set starting RPM. Further, in the process of executing a control for the cold start-2, when the second detected engine running time [sec] is greater than the second set engine running time [sec], an entry into the normal mode may be performed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exemplary flowchart showing an engine control method for cold start stabilization according to an exemplary embodiment of the present invention;

FIG. 2 is an exemplary flowchart showing a detailed procedure of cold start in the engine control method for cold start stabilization according to an exemplary embodiment of the present invention;

FIG. 3 is an exemplary flowchart showing a detailed procedure of cold start-2 in the engine control method for cold start stabilization according to an exemplary embodiment of the present invention; and

FIG. 4 is an exemplary flowchart showing an engine control method for cold start stabilization according to an exemplary embodiment of the present invention.

### DESCRIPTION OF SPECIFIC EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

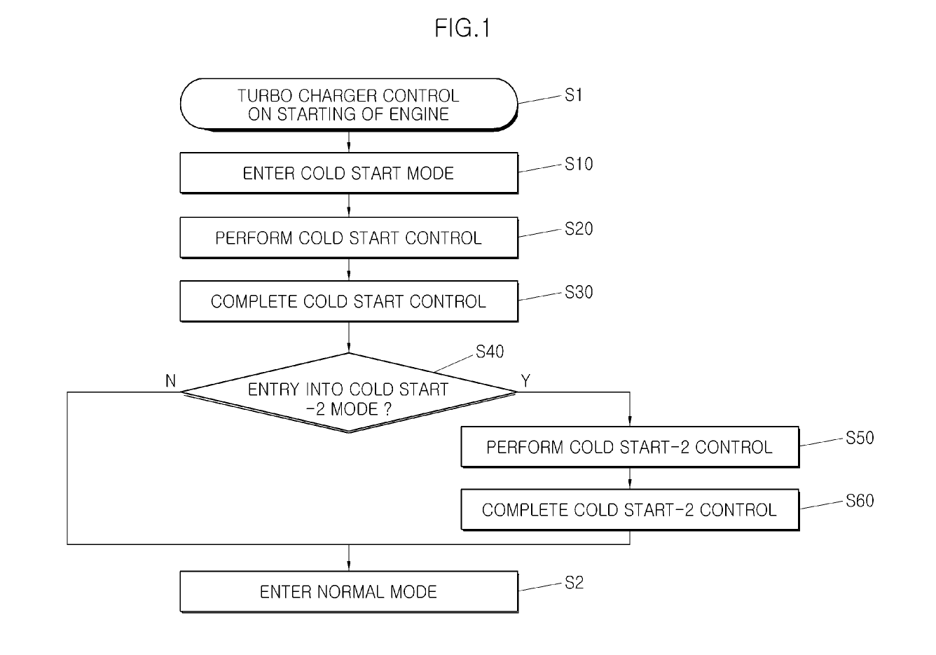

FIG. 1 is an exemplary flowchart showing an engine control method for cold start stabilization according to an exemplary embodiment of the present invention. In S1, a turbo charger control may be executed during the startup of an engine, and may be divided into a cold start mode and a cold start-2 mode. In particular, the modes may be determined with respect to the cold startability for a soaking condition of the engine.

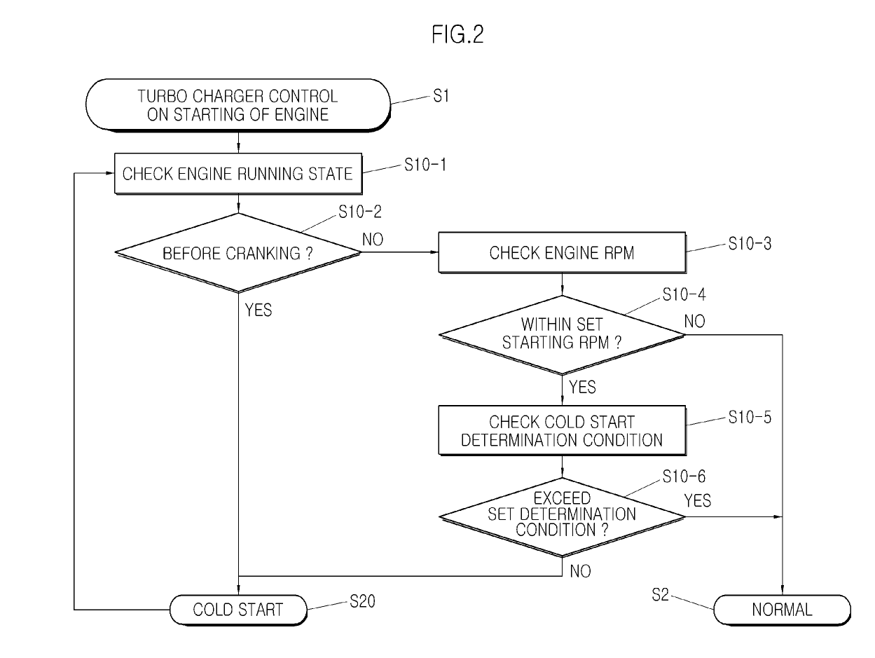

The cold start mode corresponds to a process of operating a turbo charger in the same manner as that in a cold start control of a startup boost control logic by sensing a cold start condition during a target time period within a set engine RPM before or after cranking in the startup boost control logic and then by applying a condition, of the cold start condition, that a change of an engine RPM depending on a change in the duty of the vane of the turbo charger is minimal (e.g., an engine RPM less than a predetermined RPM). Such a cold start mode may be established to enter a cold start mode in step S10, to perform a cold start control in step S20, and to complete the cold start control in step S30. Such an operation is embodied by the cold start logic shown in FIG. 2.

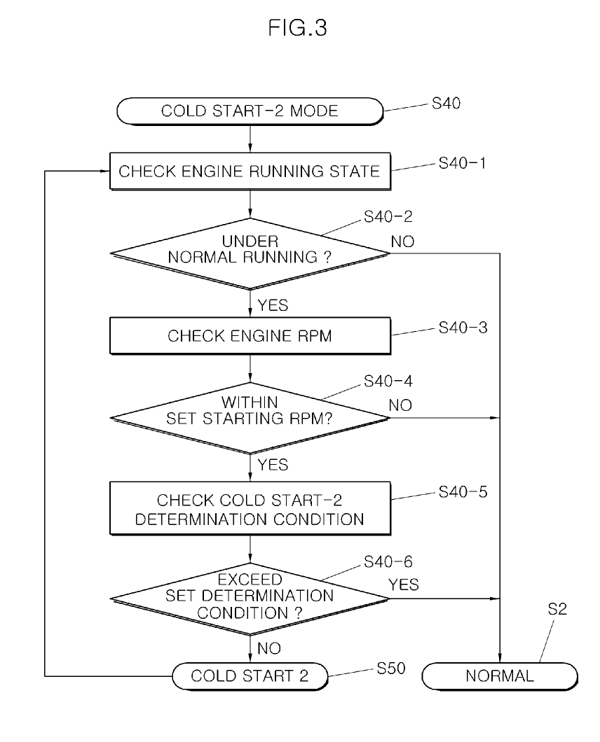

Moreover, the cold start-2 mode corresponds to a process of applying a condition, of the cold start condition, that a change of an engine RPM depending on a change in the duty of the vane of the turbo charger is substantial (e.g., an engine RPM greater than a predetermined RPM), thereby operating the turbo charger in a two-stage pre-controlling boost control manner, different from the turbo charger control in the cold start control. Therefore, of the post-cold start control in the existing startup boost control logic, an open loop control of controlling a boost pre-control value may be performed. Accordingly, optimum values obtained through tests may be employed as a turbo charger pre-control duty and a setup time of the cold start-2 condition. Such a cold start-2 mode may be established to enter a cold start-2 mode in step S40, to perform a cold start-2 control in step S50, and to complete the cold start-2 control in step S60. Such an operation is embodied by the cold start-2 logic shown in FIG. 3.

However, in the cold start-2 mode according to an exemplary embodiment of the present invention, since a selection condition may be applied as shown in step S40, a single control with the cold start mode may be performed, or a consecutive control with the cold start-2 mode after the cold start mode may be performed. For example, the selection condition for the cold start-2 mode may include a setup time, wherein the setup time may be determined using a curve of a setup time as a function of the temperature of engine coolant, to determine the selection condition based on the engine coolant. Therefore, with respect to a specific coolant condition, when a setup time is determined to be zero, the turbo charger may be, when starting the engine, operated to sense a cold start and then the process may proceed to step S2 to be under the running condition of a normal mode. In particular, step S2 corresponds to a normal mode (e.g., a boost control as the post-cold start control) executed after a turbo charger control has been completed upon starting of the engine, and corresponds to the same control manner as a post-cold start control, which is a normal running condition (e.g., an engine running status detected by engine controller) of the existing startup boost control logic.

Meanwhile, FIG. 2 shows a cold start logic executed by a controller, which represents the cold start mode entry condition of step S10 in the cold start mode executed in steps S10, S20 and S30. After Key-On (e.g., turning the vehicle key to turn on the vehicle), an engine running state may be determined as shown in step S10-1. When the engine running state determined in step S10-1 is determined to be Before Cranking in step S10-2, the procedure may proceed to step S20 in which a cold start control may be performed.

When the engine running state determined in step S10-1 is determined to be After Cranking in step S10-2, an engine RPM may be detected as shown in step S10-3, and whether the detected RPM is equal to or less than a set start RPM may be determined as shown in step S10-4. In particular, the detected RPM may be defined as a first detected RPM, and the set start RPM may be defined as a first set start RPM. Further, when the first detected RPM is greater than the first set start RPM, the procedure may enter a normal mode as shown in step S2, in which a post-cold start control that corresponds to a normal running condition in the existing startup boost control logic may be performed.

When a cold start determination condition is detected, and the detected cold start determination condition is greater than a set condition, the procedure may enter the normal mode of step S2. In addition, when the checked cold start determination condition is less than a set condition, the cold start control of step S20 may be executed. In particular, the cold start determination condition may include any one among an engine running time condition, a coolant temperature condition, and an engine oil condition, or may include a combination of the conditions. For example, when the engine running time is employed as the cold start determination condition, an engine running time [sec] may be detected in step S10-5, and whether the detected engine running time [sec] is greater than a set engine running time [sec] may be determined in step S10-6. In particular, the detected engine running time [sec] may be defined as a first detected engine running time [sec], and the set engine running [sec] may be defined as a first set engine running time [sec].

When the first detected engine running time [sec] is greater than the first set engine running time [sec], the procedure may enter the normal mode as shown in step S2, in which the post-cold start control that corresponds to a normal running condition in the existing startup boost control logic may be performed. In addition, when the first detected engine running time [sec] is less than the first set engine running time [sec], the procedure may proceed to step S20 in which the cold start control may be performed.

The cold start control of step S20 may be a process of operating a turbo charger with a control value of a vane that corresponds to an allocated bit. Therefore, similarly to the engine running time condition, the coolant temperature condition may be used with a first set coolant temperature to determine the cold start determination condition, and the engine oil temperature condition may be used with a first engine oil temperature to determine the cold start determination condition.

Meanwhile, FIG. 3 shows a cold start-2 logic executed by a controller, which represents the cold start-2 mode entry condition of step S40 in the cold start-2 mode executed in steps S40, S50 and S60. After the cold start has been completed, an engine running state may be detected again as shown in step S40-1. In response to determining that the engine running state detected in step S40-1 does not correspond to (e.g., is different than) a normal running state in step S40-2, the procedure may enter a normal mode as shown in step S2, in which a post-cold start control that corresponds to a normal running condition in the existing startup boost control logic may be performed.

Moreover, when the engine running state detected in step S40-1 is determined to be a normal running state in step S40-2, an engine RPM is may be detected again as shown in step S40-3, and whether the RPM detected in step S40-3 is equal to or less than a set start RPM may be determined as shown in step S40-4. In particular, the detected RPM may be defined as a second detected RPM, and the set start RPM may be defined as a second set start RPM. When the second detected RPM is greater than the second set start RPM, the procedure may enter a normal mode as shown in step S2, in which a post-cold start control that corresponds to a normal running condition in the existing startup boost control logic may be performed.

When the second detected RPM is less than the second set start RPM, a cold start-2 determination condition may be detected as shown in step S40-5. As shown in step S40-6, when the detected cold start-2 determination condition is greater than a set condition, the procedure may enter the normal mode of step S2. In addition, when the detected cold start-2 determination condition is less than the set condition, a cold start-2 control of step S50 may be executed.

In particular, the cold start-2 determination condition may include any one among an engine running time condition, a coolant temperature condition, and an engine oil condition, or may include a combination of the conditions. For example, when the engine running time is employed as the cold start-2 determination condition, an engine running time [sec] may be detected in step S40-5, and whether the detected engine running time [sec] is greater than a set engine running time [sec] may be determined in step S40-6. The detected engine running time [sec] may be defined as a second detected engine running time [sec], and the set engine running time [sec] may be defined as a second set engine running time [sec].

When the second detected engine running time [sec] is greater than the second set engine running time [sec], the procedure may enter the normal mode as shown in step S2, in which the post-cold start control that corresponds to a normal running condition in the existing startup boost control logic may be performed. In addition, when the second detected engine running time [sec] is less than the second set engine running time [sec], the procedure may proceed to step S50 in which a cold start-2 control may be performed.

The cold start-2 control of step S50 may be a process of operating a turbo charger with a control value of a vane that corresponds to a newly allocated bit (e.g., a second allocated bit) by newly allocating the bit other than a bit allocated (e.g., the first allocated bit) on the cold start control. Therefore, similarly to the engine running time condition, the coolant temperature condition may be used with a second set coolant temperature to determine the cold start determination condition, and the engine oil temperature condition may be used with a second engine oil temperature to determine the cold start determination condition.

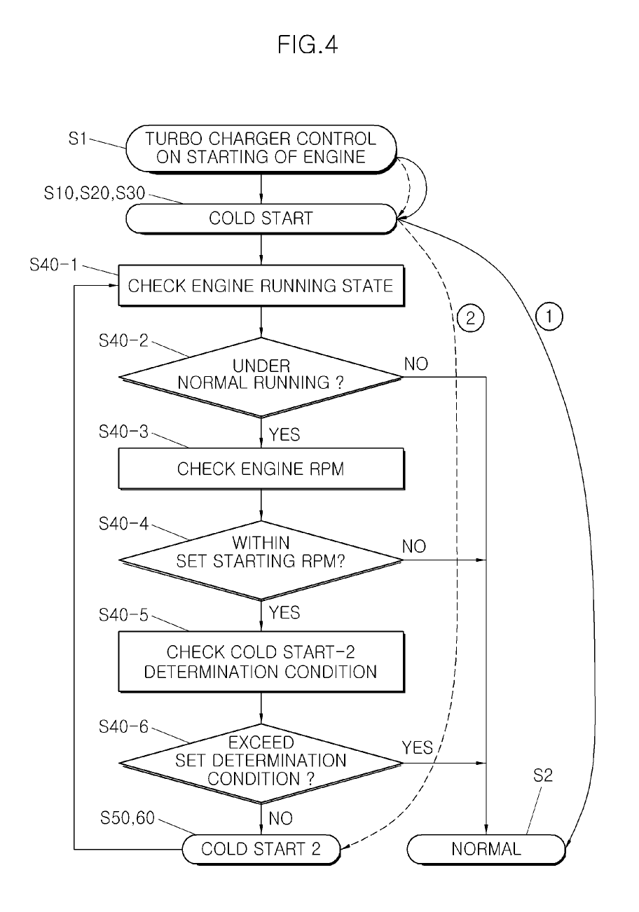

Meanwhile, FIG. 4 shows an exemplary engine control method for cold start stabilization according to an exemplary embodiment of the present invention. The engine control method may be executed by a controller having a processor and a memory.

A turbo charger control on starting of an engine, as shown in step S1, may be configured to either perform a one-stage turbo charger control of performing a control according to cold start and then entering the normal control of step S2, or to perform a two-stage pre-controlling turbo charger control of performing a control according to cold start, performing a control according to cold start-2, and then entering the normal control of step S2. For example, after running in a cold start condition, when an engine running state sensed by an engine control unit (ECU) corresponds to a normal running state, and the running state is within a range between a set minimum RPM (e.g. about 700 rpm) and a set maximum RPM (e.g. about 2000 rpm), the controller may be configured to determine to perform cold start-2. In particular, the engine RPM of MIN 700 rpm to MAX 2000 rpm may include engine idle. In the cold start-2, the operation time thereof may be measured from when the cold start has been completed. For example, when a set time is about 3 seconds, a set value for a turbo charger vane may be about 80%, the cold start-2 may be progressed to maintain the turbo charger vane at about 80% during 3 seconds after the cold start condition. Accordingly, a two-stage pre-controlling boost control may be implemented.

In particular, the one-stage turbo charger control may be the same procedure as steps S10, S20 and S30 of FIG. 1 and steps 10-1 to 10-6 of FIG. 2. Therefore, an engine running state, an engine RPM, and a set maintenance time of a turbo charger vane may be applied as factors for determining cold start and a condition, of the cold start condition, that a change of an engine RPM depending on a change in the duty of the vane of the turbo charger is minimal may be applied. Particularly, under the condition that the set time of the cold start-2 is zero, a control for the cold start-2 may not be performed. Accordingly, the turbo charger may be controlled according to a control value of the vane that corresponds to an allocated bit under a sensed cold start condition during a target period of time within a set engine RPM before or after cranking.

The two-stage pre-controlling turbo charger control may be the same procedure as steps S40, S50 and S60 of FIG. 1 and steps 40-1 to 40-6 of FIG. 3. Therefore, an engine running state, an engine RPM, and a set maintenance time of a turbo charger vane may be applied as factors for determining cold start. A set time and a turbo charger pre-control duty obtained as optimum values through a test, in which a condition, of the cold start condition, that a change of an engine RPM depending on a change in the duty of the vane of the turbo charger is substantial is used, may be applied. Accordingly, when the engine is operating normally, and satisfies a set engine RPM condition, the turbo charger may be operated according to a control value of the vane that corresponds to a newly allocated bit under a sensed cold start-2 condition during the set time.

As described above, according to the engine control method for cold start stabilization in accordance with the exemplary embodiments of the present invention, the engine control unit (ECU) which has sensed the starting of an engine may be configured to detect cold start with respect to the cold startability of a soaking condition of the engine; determine cold start; operate the turbo charger with a control value of the vane that corresponds to an allocated bit; and then either perform the one-stage turbo charger control to perform a normal control of operating the turbo charger according to an engine running condition after the cold start, or perform the two-stage pre-controlling turbo charger control to perform cold start-2 of again operating the turbo charger with a control value of the vane that corresponds to a newly allocated bit and then to perform the normal control. Accordingly, the startability of cold start may be improved without the risk of damage to the turbo charger, and particularly, a sudden movement of the vane causing a sudden change in the engine RPM may be prevented during a turbo charger control performed after the cold start, so that a more stable engine operation may be achieved.

According to the present invention, a control for a turbo charger on cold start may be performed in multi stages, to prevent a sudden change in an engine RPM, and to achieve a more stable cold start of the engine. In addition, according to the present invention, a sudden change in the engine RPM occurring when the turbo charger RPM decreases may be prevented by the two-stage pre-controlling turbo charger control, to improve the cold startability of the engine.

In addition, according to the present invention, since a design adjustment is merely required in a control method, the existing hardware may be maintained thus preventing any additional costs for improving the cold startability. Further, according to the present invention, a sudden change in the engine RPM after cold start may be prevented from occurring, to reduce vibration and noise of a vehicle body when the vehicle is started. A startup turbo charger control may be selected according to the two-stage pre-controlling turbo charger control logic, thus increasing the degree of startup mapping freedom.

While the present invention has been described with respect to the exemplary embodiments, it will be apparent to those skilled in the art that various changes and modifications may be made without departing from the spirit and scope of the invention as defined in the following claims.

What is claimed is:

1. An engine control method for cold start stabilization, comprising:
detecting, by a controller, cold start with respect to a cold start condition of a soaking condition of an engine in response to sensing a starting of the engine;
operating a turbo charger with a control value of a vane that corresponds to a first allocated bit in response to detecting the cold start; and
performing a normal control to operate the turbo charger according to an engine running condition, or performing cold start-2 to again operate the turbo charger with a control value of the vane that corresponds to a second allocated bit and then performing the normal control.

2. The method according to claim 1, wherein when a set time is zero and the normal control is performed.

3. The method according to claim 1, wherein the cold start is detected using an engine running state, an engine revolutions per minute (RPM), and a set maintenance time of a turbo charger vane.

4. The method according to claim 1, wherein the cold start is detected with a condition that a change of an engine revolutions per minute (RPM) depending on a change in the duty of the vane of the turbo charger is minimal.

5. The method according to claim 1, wherein operating a turbo charger with a control value of a vane that corresponds to a first allocated bit includes:
determining, by the controller, Before Cranking or After Cranking in a detected engine running state; and
executing, by the controller, the cold start control on the condition of the Before Cranking, while executing the cold start control or performing the normal control on the condition of the After Cranking.

6. The method according to claim 5, wherein, in connection with the condition of the After Cranking, the method includes:
setting, by the controller, a detected engine revolutions per minute (RPM) as a first detected RPM;
comparing, by the controller, the first detected RPM with a first set starting RPM;
entering, by the controller, a normal mode when the first detected RPM is greater than the first set starting RPM, while detecting a cold start determination condition when the first detected RPM is equal to or less than the first set starting RPM; and
entering, by the controller, the normal mode when the detected cold start determination condition is greater than a set condition, while executing a control for the cold start when the detected cold start determination condition is equal to or less than the set condition.

7. The method according to claim 6, wherein, in entering a normal mode when the first detected RPM is greater than the first set starting RPM, one selected from among an engine running time condition, a coolant temperature condition, and an engine oil temperature condition is applied, or a combination of the conditions is applied as the cold start determination condition.

8. The method according to claim 7, wherein when the engine running time is applied as the cold start determination condition, the method includes:
detecting, by the controller, an engine running time;
comparing, by the controller, the detected engine running time with a first set engine running time with respect to lengths thereof; and
determining, by the controller, the cold start condition based on whether the first detected engine running time is greater than the first set engine running time.

9. The method according to claim 1, wherein, in performing a normal control to operate the turbo charger according to an engine running condition, the cold start-2 is determined under a condition that a change of an engine revolutions per minute (RPM) depending on a change in a duty of the vane of the turbo charger is substantial.

10. The method according to claim 1, wherein the performing a normal control to operate the turbo charger according to an engine running condition includes:
detecting, by the controller, a set time of the cold start-2 after completing the cold start; and
performing, by the controller, the normal control when the set time is conditioned to be zero, while executing a control for the cold start-2 when the set time is conditioned greater than zero.

11. The method according to claim 10, further comprising:
determining, by the controller, a normal running of a detected engine running state;
setting, by the controller, an additionally detected engine RPM as a second detected RPM;
comparing, by the controller, the second detected RPM with a second set starting RPM;
detecting, by the controller, a cold start-2 determination condition when the second detected RPM is equal to or less than the second set starting RPM;
entering, by the controller, the normal mode when a detected cold start-2 determination condition is greater than a set condition, while executing a control for the cold start-2 when the detected cold start-2 determination condition is equal to or less than the set condition.

12. The method according to claim 11, wherein, in determining a normal running a detected engine running state, an entry into the normal mode is performed in response to detecting no normal running.

13. The method according to claim 11, wherein, in detecting a cold start-2 determination condition, an entry into the normal mode is performed when the second detected RPM is greater than the second set starting RPM.

14. The method according to claim 11, wherein, in detecting a cold start-2 determination condition, one selected from among an engine running time condition, a coolant temperature condition, and an engine oil temperature condition is applied, or a combination of the conditions is applied as the cold start-2 determination condition.

15. The method according to claim 14, wherein, when the engine running time is applied as the cold start-2 determination condition, the method includes:
detecting, by the controller, an engine running time and setting the detected engine running time as a second detected engine running;
comparing, by the controller, the second detected engine running time with a second set engine running time with respect to lengths thereof; and
determining, by the controller, the cold start-2 condition based on whether the second detected engine running time is greater than the second set engine running time.

16. The method according to claim 15, wherein, when the second detected engine running time is greater than the second set engine running time, an entry into the normal mode is performed.
